(19) United States
(12) Patent Application Publication
(10) Pub. No.: US 2010/0243088 A1
(43) Pub. Date: Sep. 30, 2010

(54) Composite Faucet Body Assembly and the Method for Making It

(76) Inventor: Gary Wu, Homei Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/413,773

(22) Filed: Mar. 30, 2009

(51) Int. Cl. F16K 21/00

(52) U.S. Cl. 137/801; 164/69.1

(57) ABSTRACT

A composite faucet body assembly includes an inner separation member and a faucet body encompassing and covering a periphery of the inner separation member. The inner separation member is provided with at least one water inlet port and at least one water outlet port. Thus, the inner separation member is made of a nontoxic lead-contained thin copper tube whose lead content is smaller than 0.25% to prevent an excessive lead content from infiltrating into the drinking water by separation of the inner separation member so as to protect a user's safety. In addition, the faucet body has a lower melting point so that the faucet body is formed by casting at a lower temperature, thereby decreasing the cost of fabrication.

### BACKGROUND OF THE INVENTION

1. Field of the Invention

The present invention relates to a faucet body assembly and, more particularly, to a composite faucet body assembly and a method for making the composite faucet body assembly.

2. Description of the Related Art

A conventional faucet body 40 in accordance with the prior art shown in FIGS. 5 and 6 comprises at least one water inlet port 41 and at least one water outlet port 42. The water inlet port 41 has an outer surface provided with an outer threaded portion 43. The faucet body 40 is worked by casting or forging to form the water inlet port 41 and the water outlet port 42. Then, the faucet body 40 is worked by a secondary process to form the outer threaded portion 43. The faucet body 40 is made of brass which contains lead to provide a lubricating effect to facilitate the working process of the faucet body 40. However, the drinking water will be toxic due to the lead contained in the faucet body 40, thereby causing danger to the user. Thus, the faucet body 40 can be made of a nontoxic lead-contained copper whose lead content is smaller than 0.25%. However, the nontoxic lead-contained copper cannot provide a lubricating effect so that the faucet body 40 is not worked easily and quickly, thereby lengthening the working time and increasing the cost of fabrication. In addition, the nontoxic lead-contained copper has a higher melting point so that the faucet body 40 is worked at a higher temperature, thereby consuming the energy and increasing the cost of fabrication. Further, the nontoxic lead-contained copper easily produces bubbles during the casting process, thereby decreasing the quality of the faucet body 40.

### BRIEF SUMMARY OF THE INVENTION

In accordance with the present invention, there is provided a composite faucet body assembly, comprising an inner separation member and a faucet body encompassing and covering a periphery of the inner separation member. The inner separation member is provided with at least one water inlet port and at least one water outlet port.

In accordance with the present invention, there is also provided a method for manufacturing a composite faucet body assembly, comprising a) forming an inner separation member with at least one water inlet port and at least one water outlet port, b) placing the inner separation member into a forming die, c) pouring and casting a liquid hot metal between the forming die and the inner separation member to form a faucet body encompassing and covering a periphery of the inner separation member so as to form a composite faucet body assembly containing the inner separation member and the faucet body, and d) opening the forming die to remove the composite faucet body assembly from the forming die.

The primary objective of the present invention is to provide a composite faucet body assembly, wherein the inner separation member is made of a nontoxic lead-contained thin copper tube whose lead content is smaller than 0.25% to prevent an excessive lead content from infiltrating into the drinking water by separation of the inner separation member so as to protect a user's safety.

Another objective of the present invention is to provide a composite faucet body assembly, wherein the inner separation member has a wall thickness much smaller than that of the faucet body to save the cost of material.

A further objective of the present invention is to provide a composite faucet body assembly, wherein the faucet body has a lower melting point so that the faucet body is formed by casting at a lower temperature, thereby decreasing the cost of fabrication.

A further objective of the present invention is to provide a composite faucet body assembly, wherein the inner separation member is not formed by casting so that the inner separation member will not produce bubbles during the working process so as to enhance the quality of the product.

A further objective of the present invention is to provide a composite faucet body assembly, wherein the faucet body has a lower melting point so that the faucet body can be reused easily and quickly so as to satisfy the economical benefit.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a composite faucet body assembly in accordance with the preferred embodiment of the present invention.

FIG. 2 is a perspective view of an inner separation member of the composite faucet body assembly as shown in FIG. 1.

FIG. 3 is a side cross-sectional view of the composite faucet body assembly as shown in FIG. 1.

FIG. 4 is a perspective view showing fabrication of the composite faucet body assembly as shown in FIG. 1.

FIG. 5 is a perspective view of a conventional faucet body in accordance with the prior art.

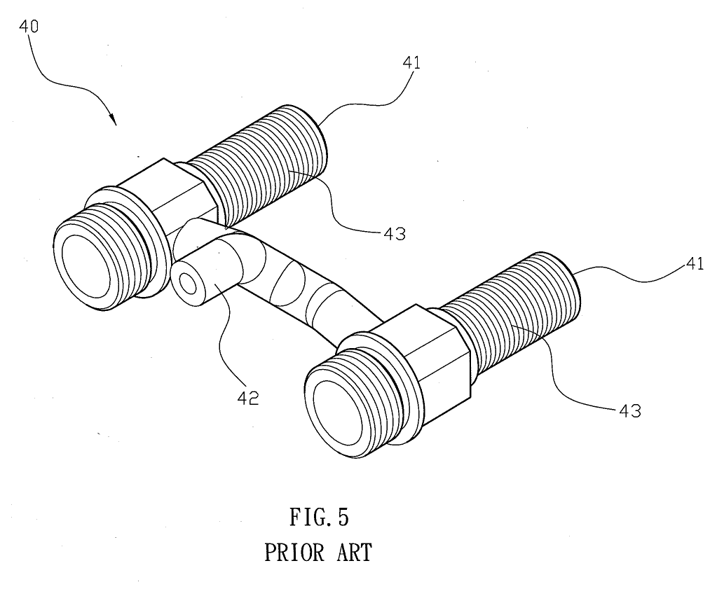

FIG. 6 is a side cross-sectional view of the conventional faucet body as shown in FIG. 5.

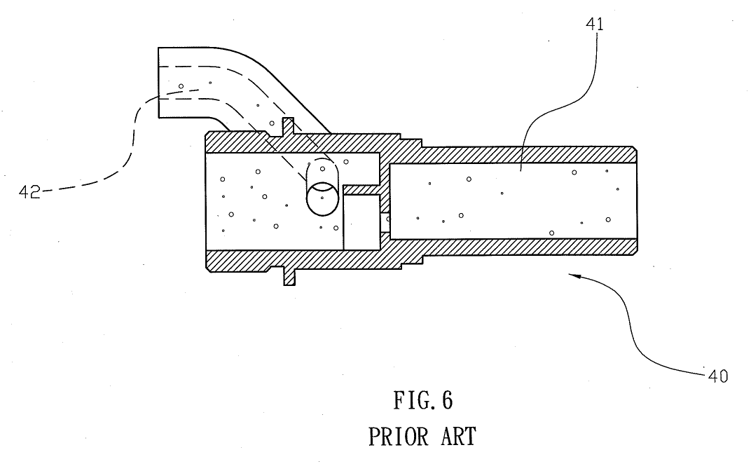

### DETAILED DESCRIPTION OF THE INVENTION

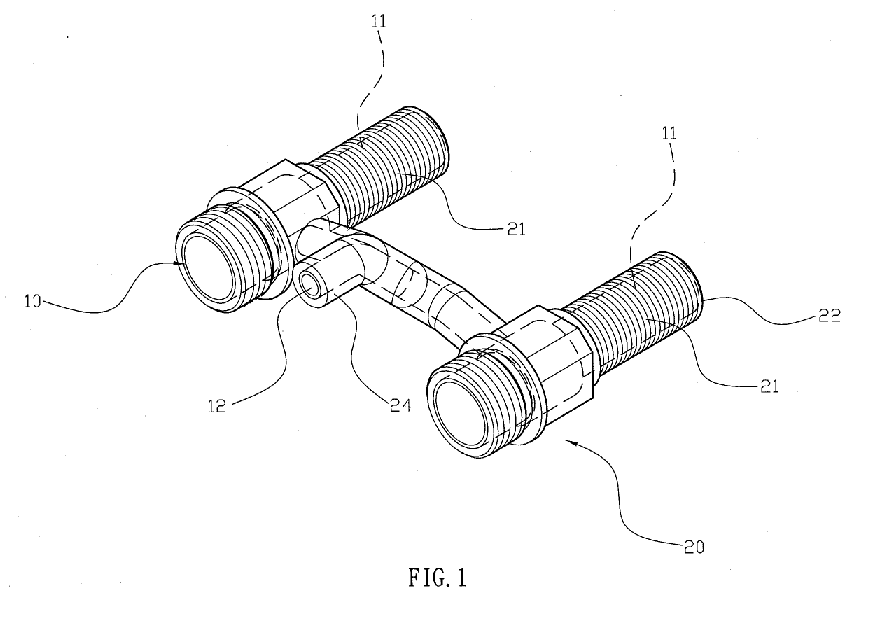

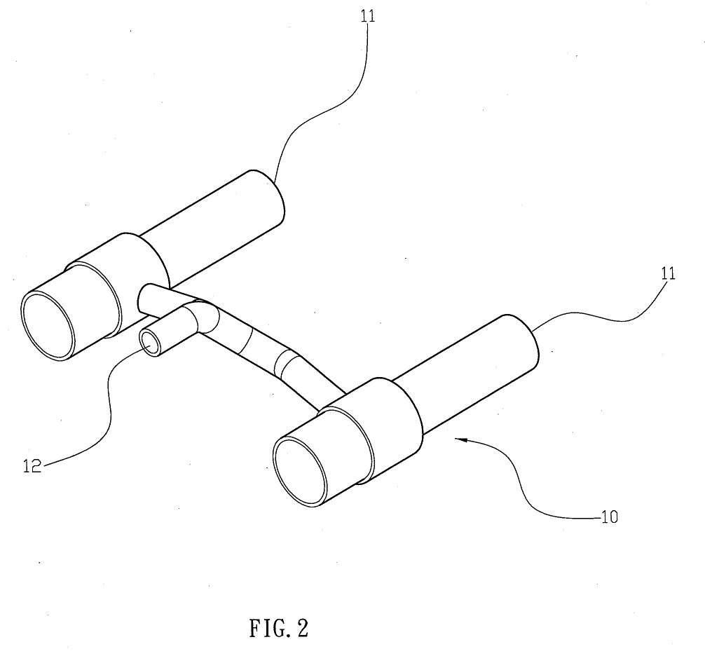

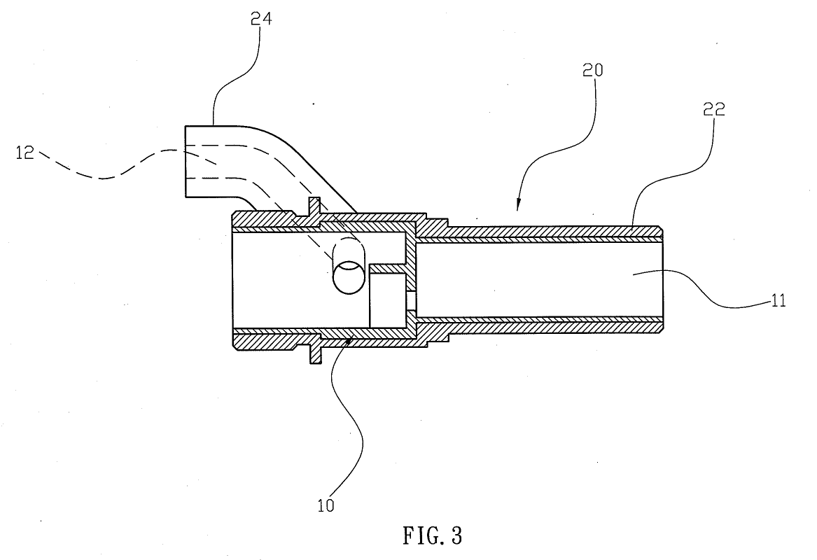

Referring to the drawings and initially to FIGS. 1-3, a composite faucet body assembly in accordance with the preferred embodiment of the present invention comprises an inner separation member 10 and a faucet body 20 encompassing and covering a periphery of the inner separation member 10.

The inner separation member 10 is fully covered by and hidden in the faucet body 20 so that the inner separation member 10 and the faucet body 20 are combined integrally. The inner separation member 10 is provided with at least one water inlet port 11 and at least one water outlet port 12. The inner separation member 10 is made of metal. Preferably, the inner separation member 10 is made of a nontoxic lead-contained thin copper tube whose lead content is smaller than 0.25%. Alternatively, the inner separation member 10 is made of a galvanized iron tube. The inner separation member 10 is worked by cutting, soldering and punching to form the water inlet port 11 and the water outlet port 12. The inner separation member 10 has a wall thickness much smaller than that of the faucet body 20.

The faucet body 20 is provided with at least one first enclosure 22 encompassing and covering the water inlet port 11 of the inner separation member 10 and at least one second enclosure 24 encompassing and covering the water outlet port 12 of the inner separation member 10. The first enclosure 22 of the faucet body 20 has an outer surface provided with an outer threaded portion 21. The faucet body 20 is formed by casting. The faucet body 20 is made of metal having a melting point smaller than that of the inner separation member 10. Thus, the faucet body 20 has a melting point smaller than that of the inner separation member 10 so that the faucet body 20 will not break the water inlet port 11 and the water outlet port 12 of the inner separation member 10 during the casting process.

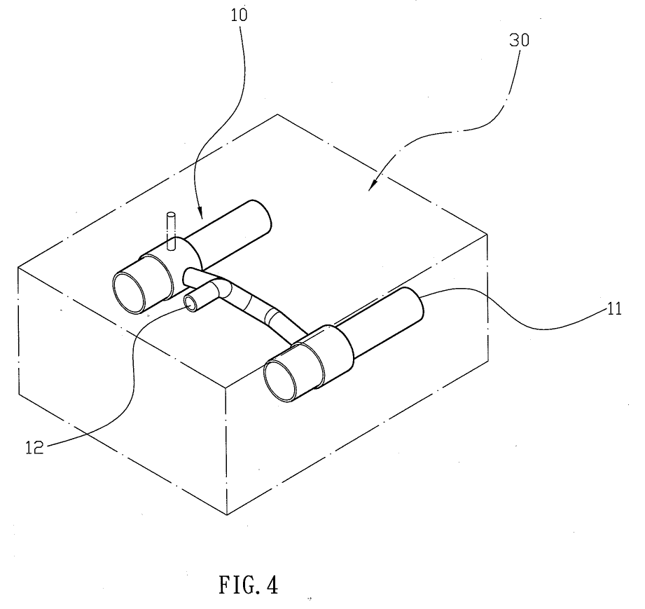

In fabrication, referring to FIG. 4 with reference to FIGS. 1-3, a method for manufacturing a composite faucet body assembly in accordance with the preferred embodiment of the present invention comprises a) forming an inner separation member 10 with at least one water inlet port 11 and at least one water outlet port 12, b) placing the inner separation member 10 into a forming die 30, c) pouring and casting a liquid hot metal between the forming die 30 and the inner separation member 10 to form a faucet body 20 encompassing and covering a periphery of the inner separation member 10 so as to form a composite faucet body assembly containing the inner separation member 10 and the faucet body 20, and d) opening the forming die 30 to remove the composite faucet body assembly from the forming die 30. Thus, the faucet body 20 has a melting point smaller than that of the inner separation member 10 so that the faucet body 20 will not break the water inlet port 11 and the water outlet port 12 of the inner separation member 10 during the casting process.

The method for manufacturing a composite faucet body assembly in accordance with the preferred embodiment of the present invention further comprises e) working the faucet body 20 to form an outer threaded portion 21 on an outer surface of the faucet body 20.

Accordingly, the inner separation member 10 is made of a nontoxic lead-contained thin copper tube whose lead content is smaller than 0.25% to prevent an excessive lead content from infiltrating into the drinking water by separation of the inner separation member 10 so as to protect a user's safety. In addition, the inner separation member 10 has a wall thickness much smaller than that of the faucet body 20 to save the cost of material. Further, the faucet body 20 has a lower melting point so that the faucet body 20 is formed by casting at a lower temperature, thereby decreasing the cost of fabrication. Further, the inner separation member 10 is not formed by casting so that the inner separation member 10 will not produce bubbles during the working process so as to enhance the quality of the product. Further, the faucet body 20 has a lower melting point so that the faucet body 20 can be reused easily and quickly so as to satisfy the economical benefit.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A composite faucet body assembly, comprising:
an inner separation member;
a faucet body encompassing and covering a periphery of the inner separation member.

2. The composite faucet body assembly of claim 1, wherein
the inner separation member is fully covered by and hidden in the faucet body;
the inner separation member and the faucet body are combined integrally.

3. The composite faucet body assembly of claim 1, wherein the inner separation member is provided with at least one water inlet port and at least one water outlet port.

4. The composite faucet body assembly of claim 3, wherein the faucet body is provided with at least one first enclosure encompassing and covering the water inlet port of the inner separation member and at least one second enclosure encompassing and covering the water outlet port of the inner separation member.

5. The composite faucet body assembly of claim 4, wherein the first enclosure of the faucet body has an outer surface provided with an outer threaded portion.

6. The composite faucet body assembly of claim 1, wherein
the inner separation member is made of metal;
the faucet body is made of metal having a melting point smaller than that of the inner separation member.

7. The composite faucet body assembly of claim 6, wherein the inner separation member is made of a nontoxic lead-contained thin copper tube whose lead content is smaller than 0.25%.

8. The composite faucet body assembly of claim 1, wherein the inner separation member is worked by cutting, soldering and punching.

9. The composite faucet body assembly of claim 1, wherein the inner separation member has a wall thickness much smaller than that of the faucet body.

10. The composite faucet body assembly of claim 1, wherein the faucet body is formed by casting.

11. The composite faucet body assembly of claim 6, wherein the inner separation member is made of a galvanized iron tube.

12. A method for manufacturing a composite faucet body assembly, comprising:
a) forming an inner separation member with at least one water inlet port and at least one water outlet port;
b) placing the inner separation member into a forming die;
c) pouring and casting a liquid hot metal between the forming die and the inner separation member to form a faucet body encompassing and covering a periphery of the inner separation member so as to form a composite faucet body assembly containing the inner separation member and the faucet body;
d) opening the forming die to remove the composite faucet body assembly from the forming die.

13. The method of claim 12, further comprising:
e) working the faucet body to form an outer threaded portion on an outer surface of the faucet body.

14. The method of claim 12, wherein
the inner separation member is fully covered by and hidden in the faucet body;
the inner separation member and the faucet body are combined integrally.

15. The method of claim 12, wherein the faucet body is provided with at least one first enclosure encompassing and covering the water inlet port of the inner separation member and at least one second enclosure encompassing and covering the water outlet port of the inner separation member.

16. The method of claim 12, wherein
the inner separation member is made of metal;
the faucet body is made of metal having a melting point smaller than that of the inner separation member.

17. The method of claim 12, wherein the inner separation member is made of a nontoxic lead-contained thin copper tube whose lead content is smaller than 0.25%.

18. The method of claim 12, wherein the inner separation member is worked by cutting, soldering and punching.

19. The method of claim 12, wherein the inner separation member has a wall thickness much smaller than that of the faucet body.
